(19) United States
(12) Patent Application Publication
(10) Pub. No.: US 2014/0334398 A1
(43) Pub. Date: Nov. 13, 2014

(54) APPARATUS AND METHOD FOR CONTROLLING RADIO RESOURCE ALLOCATION FOR LOW POWER SENSOR COMMUNICATION SERVICE

(71) Applicant: Electronics and Telecommunications Research Institute, Daejeon-si (KR)

(72) Inventors: Geon-Min YEO, Daejeon-si (KR); Soon-Yong SONG, Daejeon-si (KR); Young-Il KIM, Daejeon-si (KR); Won RYU, Seoul (KR)

(73) Assignee: Electronics and Telecommunications Research Institute, Daejeon-si (KR)

(21) Appl. No.: 14/256,566

(22) Filed: Apr. 18, 2014

(30) Foreign Application Priority Data
May 9, 2013 (KR) 10-2013- 0052722

(51) Int. Cl. H04W 72/04

(52) U.S. Cl. CPC H04W 72/048
USPC 370/329

(57) ABSTRACT

A method for controlling radio resource allocation for a low power sensor communication service by a relay coordinator. The method may include configuring a frame that includes a Contention Access Period (CAP) offset and a Contention Free Period (CFP) offset of variable sizes, and an Relay Period (RP) that relays data between a Personal Area Network (PAN) coordinator and one or more lower hierarchical devices; and generating a beacon frame that includes information of the frame configuration, and transmitting the beacon frame to the one or more lower hierarchical devices; and transmitting data, which is received from the one or more lower hierarchical devices through the CFP, to the PAN coordinator through the RP, or transmitting data, which is received from the PAN coordinator through the RP, to lower hierarchical nodes through the CFP.

### CROSS-REFERENCE TO RELATED APPLICATION(S)

This application claims the benefit under 35 U.S.C. §119(a) of Korean Patent Application No. 10-2013-0052722, filed on May 9, 2013, in the Korean Intellectual Property Office, the entire disclosure of which is incorporated herein by reference for all purposes.

### BACKGROUND

1. Field

The following description relates to a sensor communication service technology, more specifically, an apparatus and method for controlling wireless resource allocation for sensor communications.

2. Description of the Related Art

A sensor network is a type of a wireless network for transmitting sensing information generated in a sensor to a final destination through wireless communications. The sensor network is based on a lower transmission rate of data compared to period mobile communications; however, due to difficult environments for providing wired power supply, the sensor network is operated mostly on battery.

Also, since the sensor network is operated in a situation with limited power, strength of a transmission radio wave is limited, which results in forming short radio wave coverage. Thus, to transmit the data to the final destination, an apparatus playing a role equivalent to a mobile communication relay is necessary, wherein the apparatus is recognized as performing an important role in sensor communications.

A conventional mechanism, which includes the apparatus performing a role of the relay, limits the number of sensors acceptable in one channel, and acts as a big weakness in flexibly managing the coverage. In other words, the conventional mechanism is not possible for flexibly accepting a plurality of the sensors in various traffic situations, and cannot ensure maximum resource allocation because a radio resource hole is generated.

### SUMMARY

The following description relates to an apparatus and method for controlling a radio resource allocation for a low power sensor communication service so as to accept a plurality of sensors, expand sensor network coverage, and attempt to accomplish a radio resource optimization of the sensor network.

In addition, the following description relates to an apparatus and method for controlling wireless resource allocation for a low power sensor communication service, so as to provide a quick signaling for a resource configuration between a plurality of sensors in various traffic situations, and minimize a resource allocation delay.

In one general aspect, an apparatus and method may include configuring a frame that includes a Competition Access Period (CAP) offset and a Competition Free Period (CFP) offset of variable sizes; and generating a beacon frame that includes information of the frame configuration, and transmitting the beacon frame to one or more lower-level connected coordinators or sensor devices.

In another general aspect, an apparatus and method may include configuring a frame that includes a CAP offset and a CFP offset of variable sizes, and a relay period (RP) that relays data between the PAN coordinator and one or more lower hierarchical devices; generating a beacon frame that includes information of the frame configuration, and transmitting the beacon frame to the one or more lower hierarchical devices; and transmitting data, which is received from the one or more lower hierarchical devices through the CFP, to the PAN coordinator through the RP, or transmitting data, which is received from the PAN coordinator through the RP, to lower hierarchical nodes through the CFP.

In another general aspect, as a PAN coordinator, an apparatus and method may include a frame configuration unit configured to configure a frame that includes a CAP offset and a CFP offset of variable sizes; and a beacon transmitting unit configured to generate a beacon frame that includes information of frame configuration, and transmit the beacon frame to one or more lower hierarchical coordinators or sensor devices.

In another general aspect, an apparatus and method may include a frame configuration unit configured to configure a frame that includes a CAP offset and a CFP offset of variable sizes, and a RP that relays data between a PAN coordinator and one or more lower hierarchical is devices; a beacon transmitting unit configured to generate a beacon frame that includes information of the frame configuration, and to transmit the beacon frame to the one or more lower hierarchical devices; and a data relaying unit configured to transmit data, which is received from the one or more lower hierarchical devices through a CFP, to the PAN coordinator through the RP, or transmit data, which is received from the PAN coordinator through the RP, to the one or more lower hierarchical nodes through a CFP.

Other features and aspects may be apparent from the following detailed description, the drawings, and the claims.

### BRIEF DESCRIPTION OF THE DRAWINGS

FIG. 1 is a diagram illustrating an example of a composition of IEEE 802.15.4 channel.

FIG. 2 is a diagram illustrating an example of a composition of a hierarchical sensor network.

FIG. 3 is a diagram illustrating an example of radio resource allocation for each IEEE 802.15.4 channel.

FIG. 4 is a diagram illustrating an example of a relay-based sensor network.

FIG. 5 is a diagram illustrating an example of a frame structure to compose a Contention Access Period (CAP) and a Contention Free Period (CFP) of variable sizes.

FIG. 6 is a diagram illustrating an example of a frame structure managed by a coordinator with a relay function.

FIG. 7 is a diagram illustrating an example of an association between frame structures operated by a Personal Area Network (PAN) coordinator and by a relay coordinator.

FIG. 8 is a diagram illustrating an example of a whole frame structure that relays data through one channel.

FIG. 9 is a flowchart illustrating an example of a method for controlling radio resource allocation for a low power sensor communication service by a Personal Area Network (PAN) coordinator.

FIG. 10 is a flowchart illustrating an example of a method for controlling radio resource allocation for a low power sensor communication service by a relay coordinator.

FIG. 11 is a diagram illustrating an example of a PAN coordinator allocating radio resources for a low power sensor communication service.

FIG. 12 is a diagram illustrating an example of a relay coordinator allocating radio resources for a low power sensor communication service.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

As an international standard for a wireless sensor communication network configuration, IEEE 802.15.4 is representative, which defines an interface (named ‘primitive’) with an upper is layer for a physical layer (PHY)/medium access control (MAC) layer, and an application service for a low power communication between sensors. A basic performance level of IEEE 802.15.4 ensures a data transmission rate at maximum 250 kbps if Offset Quadrature Phase-Shift Keying (OQPSK) modulation method is applied, and does not include a basic channel coding mechanism for low power consumption.

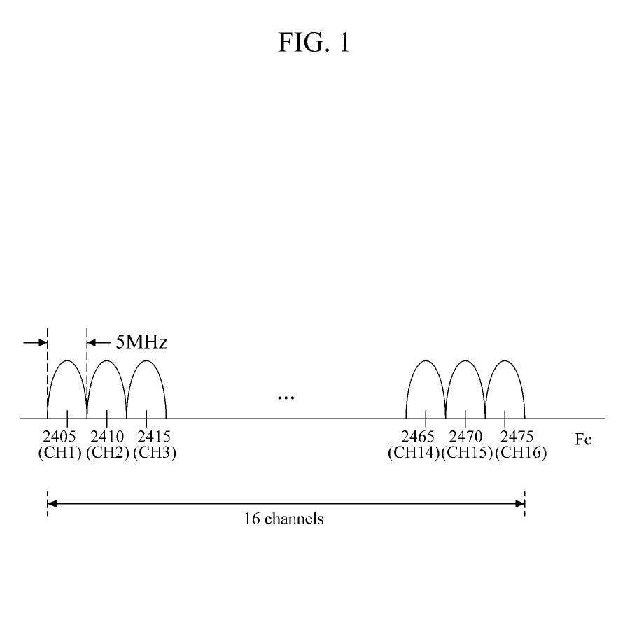

FIG. 1 is a diagram illustrating an example of a composition of IEEE 802.15.4 channel.

Referring to FIG. 1, total 16 channels are operated in IEEE 802.15.4, which are composed of 5 MHz unit channels in a 2.4 GHz band. Each channel may include Personal Area Network (PAN), and one PAN is a basic unit composing a sensor network. That is, in composing PAN, if a coordinator selects one channel, and regularly transports a beacon through the channel, devices existing within a coverage area that detects the transported beacon may join in the PAN and compose the PAN.

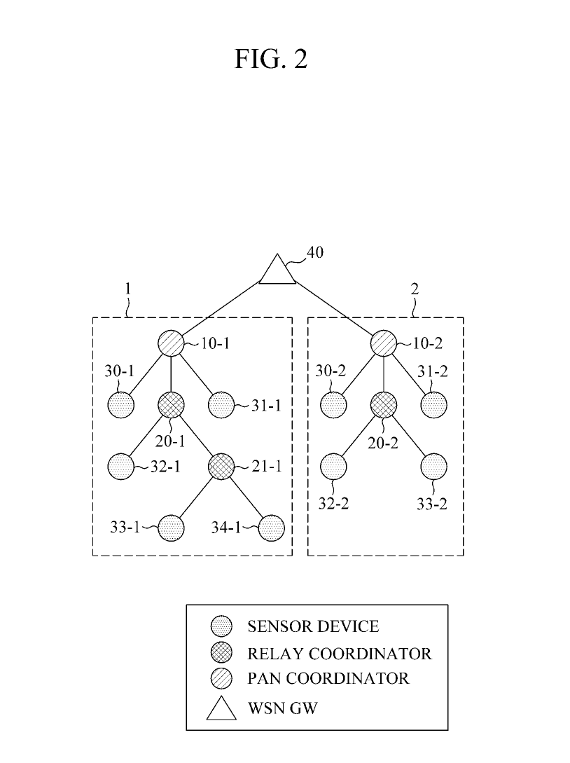

FIG. 2 is a diagram illustrating an example of a composition of a hierarchical sensor network.

Referring to FIG. 2, sensors in a wireless sensor network are connected to a server (not illustrated) that is connected to a wired internet backbone network through a gateway (GW) (40). PANs 1 and 2 may be extended to a peer to peer (P2P) cluster tree structure. That is, a plurality of PANs 1 and 2 take each different channel within overlapped radio wave coverage.

Each of the PANs 1 and 2 is operated by PAN coordinators 10-1 and 10-2, which are the highest nodes connected to the gateway 40. Also, each of the PAN coordinators 10-1 and 10-2 may be connected to a plurality of sensors 30-1, 30-2, 31-1, and 31-2 or relay coordinators 20-1 and 20-2. The relay coordinators 20-1 and 20-2 of the other relay coordinator 21-1 may be connected to a plurality of sensors 32-1, 32-2, and 33-2, or another relay coordinator 21-1. That is, one PAN is formed in one channel, which is a wireless resource that all the sensors, relay coordinators, and PAN coordinators within the same PAN share together at the same time.

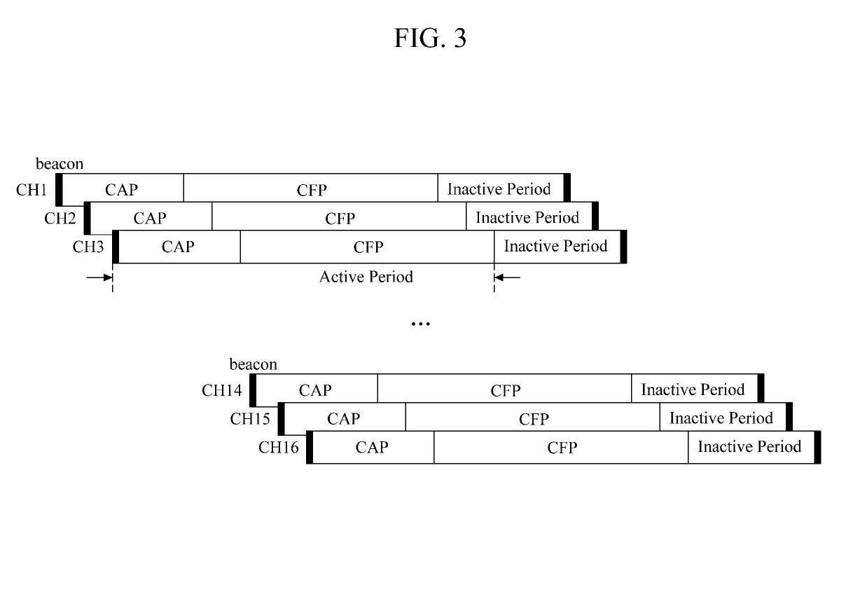

FIG. 3 is a diagram illustrating an example of radio resource allocation for each IEEE 802.15.4 channel.

Referring to FIG. 3, one frame transmitted within one channel may include beacon interval, an active period in which nodes transmits/receives data, and an inactive period in which nodes sleep or standby in the lowest power consumption state.

A beacon frame is transmitted at a predetermined time interval, and a time interval between each beacon may compose a wireless frame.

The active period is operated after being separated into a Contention Access Period (CAP) and a Contention Free Period (CFP). The CAP is a period where all sensors connected to coordinators can transmit/receive data anytime. In a case in which a plurality of the sensors transmit data to the CAP at the same time, collisions may occur. However, the CFP is a period to which its own transmission/reception time of each sensor is allocated. In the CFP, collisions may be avoided, which are caused from the transmission between the sensors.

The inactive period is a period where transmission/reception is not allowed. In the inactive period, each device may be operated in a power saving mode with a radio frequency (RF) function turned off.

IEEE 802.15.4 limits the active period to (1/2)n (n=0, 1, 2, . . . ) of the beacon interval (namely, a wireless frame). In other words, IEEE 802.15.4 may use all the wireless frames as the active periods, or use the wireless frames as much as the multiplicative inverse of 2.

As mentioned above in FIG. 2, a plurality of relay coordinators connected to one PAN coordinator may exist in one channel. Each relay coordinator may transmit a beacon independent of the PAN coordinator, and the beacon interval of each relay coordinator may form its own wireless frame of each coordinator. That is, the active period of each relay coordinator is connected to the PAN coordinator should be located in the inactive period formed by the PAN coordinator. Otherwise, there may be collisions in data transmission between the sensors connected to the PAN coordinator and the sensors connected to the relay coordinators.

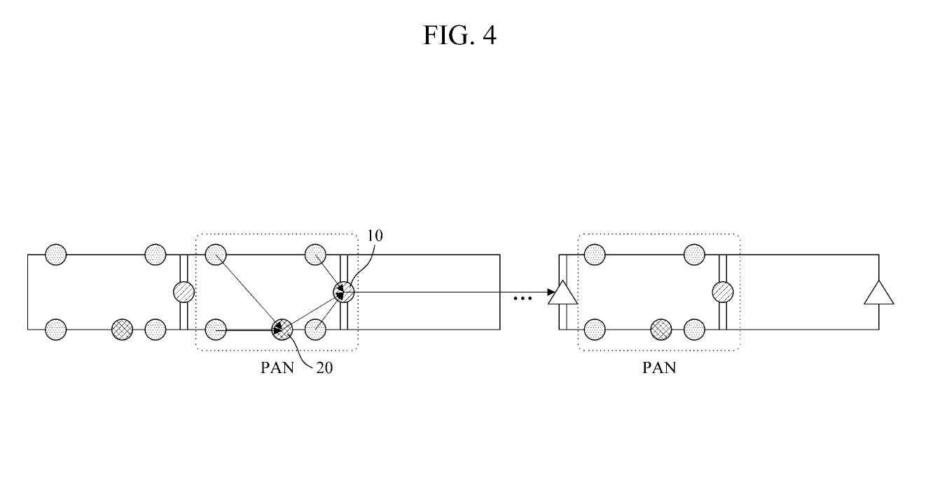

FIG. 4 is a diagram illustrating an example of a relay-based sensor network.

Referring to FIG. 4, a relay coordinator 20 may be used to overcome a transmission distance between a sensor and a PAN coordinator 10. That is, the relay coordinator 20 may play a role of the relay between the PAN coordinator and the sensor, using an inactive period of the PAN coordinator.

However, in a case in which the number of the relay coordinators grows, a mechanism provided in IEEE 802.15.4 is considerably limited in using radio resources. If the mechanism has a relay function, the active period, which devices directly connected to the PAN coordinator can use, is reduced to half. This mechanism may limit the number of the sensors acceptable in one channel, and act as a big weakness in a flexible management of coverage.

Accordingly, the apparatus provides a mechanism, which accepts a plurality of the sensors and expands sensor network coverage, and attempts to ultimately accomplish a radio resource optimization of the sensor network. For the optimization, a method for forming a CAP and a CFP of variable sizes is provided hereafter.

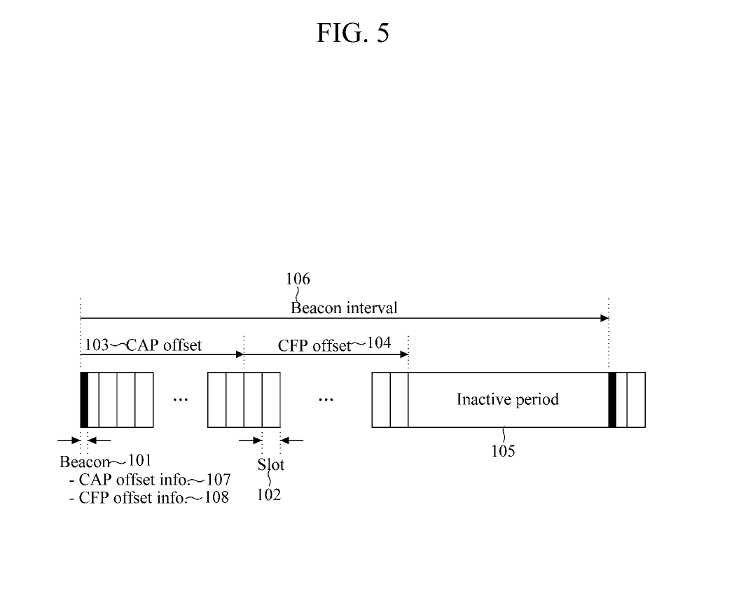

FIG. 5 is a diagram illustrating an example of a frame structure to compose a CAP and a CFP of variable sizes.

Referring to FIG. 5, a beacon 101 transmitted by a PAN coordinator may be transmitted with a regular beacon interval 106. A transmission slot is composed of a fixed size of a basic slot 102, and becomes a basic unit of a CAP offset 103 and a CFP offset 104.

In embodiments of the apparatus and method, the beacon 101 may include information of the CAP offset and the CFP offset, and a device receiving the beacon 101 may know lengths of is the CAP and the CFP. The CAP offset and the CFP offset each are defined as the number of the basic slots 102, and a sum of the CAP offset and the CFP offset may not be greater than the beacon interval 106. Through that composition, the CAP and the CFP of variable sizes, may be formed.

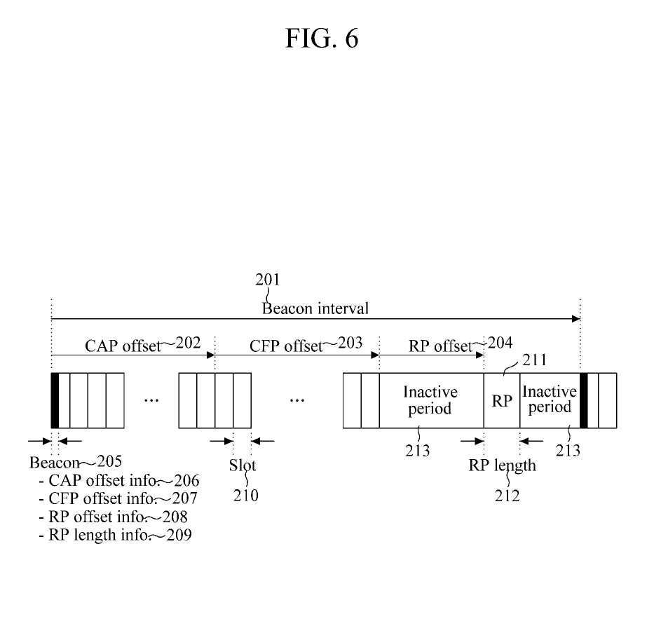

FIG. 6 is a diagram illustrating an example of a frame structure managed by a coordinator with a relay function.

Referring to FIG. 6, a relay coordinator may be connected to a PAN coordinator or other relay coordinators, as an upper hierarchical level. Also, the relay coordinator may be connected to a sensor or other relay coordinators, as a lower hierarchical level. A frame managed by the relay coordinator may include a beacon 205, a CAP, and a CFP, to transmit/receive data with lower hierarchical devices. Operation methods of a CAP offset 202 and a CFP offset 203 are identical to the description mentioned in FIG. 5.

A relay period (RP) 211 is operated to transmit/receive data with the upper hierarchical devices (PAN coordinators or other relay coordinators). A function of the RP is to transmit data received from the lower hierarchical devices to the upper hierarchical devices, and vice versa. In other words, the RP is in charge of the relay function. Here, a sum of the CAP offset 202, the CFP offset 203, the RP offset 204, and an RP length 212 may not be greater than a beacon interval 201.

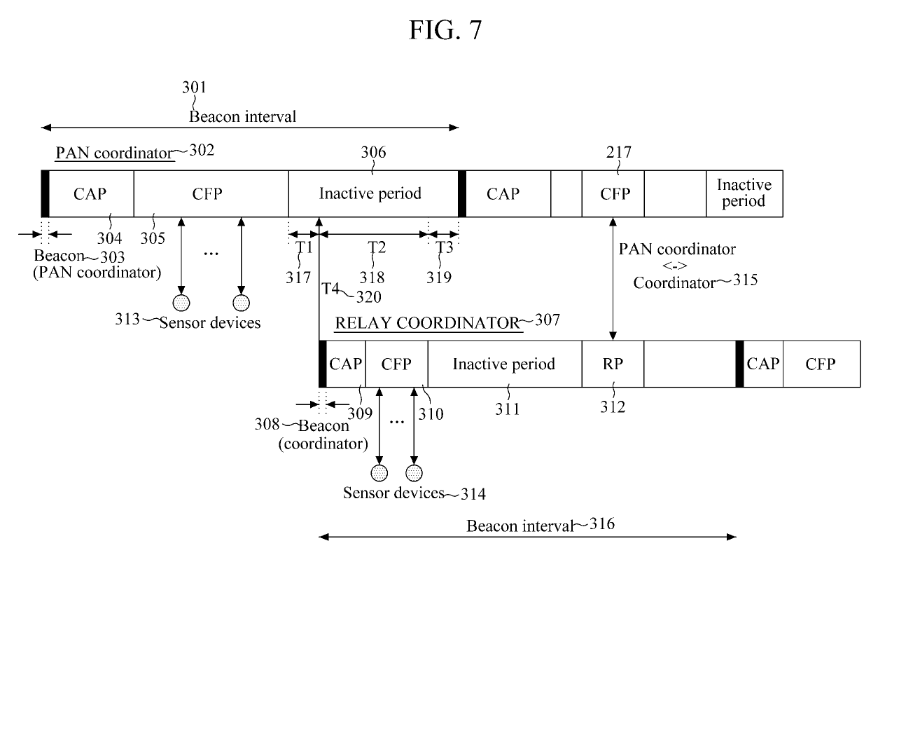

FIG. 7 is a diagram illustrating an example of a connection between frame structures operated by a Personal Area Network (PAN) coordinator and by a relay coordinator.

Referring to FIG. 7, a PAN coordinator 302 includes, as a lower hierarchical level, a plurality of sensor devices 313 and one relay coordinator 307, which is relevant to a PAN coordinator 302 and which is a structure with a plurality of sensor devices 314 as a lower hierarchical level.

The plurality of the sensors 313 relevant to the PAN coordinator 302 may transmit/receive data to the CFP 305 each allocated to sensors 313.

A beacon intervals 316 transmitted from the relay coordinator 307 may have the same length as a beacon interval 301 transmitted from the PAN coordinator 302. A starting point T4 320 of a beacon 308 transmitted from the relay coordinator 307 should exist after a starting point (T1>0) of an inactive period 306 of the PAN coordinator 302. Also, a sum T2 318 of the beacon 308, the CAP 309, and the CFP 310 of the relay coordinator 307 should be less than the inactive period 306 (T3 319>0).

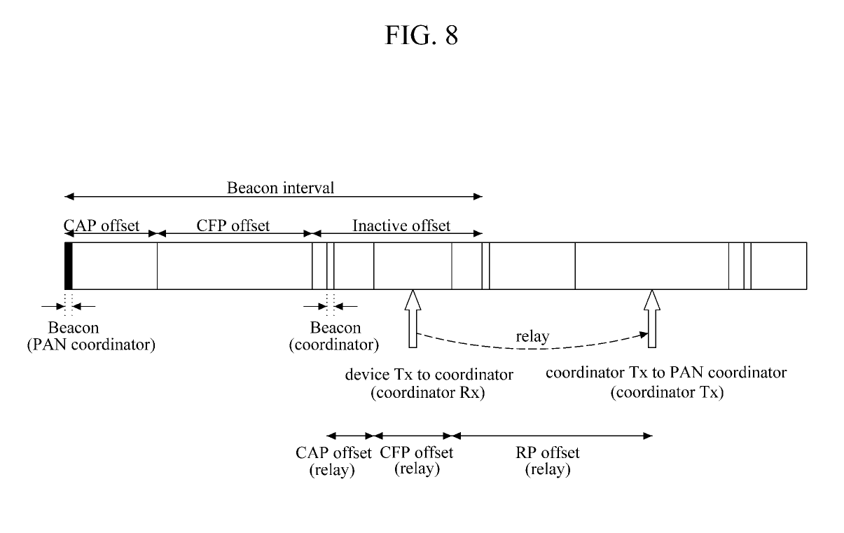

Those conditions enable data transmission between the PAN coordinator 302 and the relay coordinator 307 not to be collided. The relay coordinator 307 performs communications with lower hierarchical devices 314, and transmits data, which is received through the CFP 310 from the lower hierarchical devices 314, to the PAN coordinator 302 through the RP 312. Here, the RP 312 of the relay coordinator 307 is equivalent to a CFP 217, which is an interval that the PAN coordinator 302 allocates to the relay 307. Conversely, the relay coordinator 307 transmits data, which is received through the CFP 217 from the PAN coordinator 302, to the lower hierarchical devices 314 through the CFP 310. FIG. 8 is a diagram illustrating an example of a whole frame structure that relays data through one channel.

Referring to FIG. 8, as a relay coordinator receives data during an inactive period (inactive offset) of a frame operated by a PAN coordinator, the data is transmitted to the PAN coordinator during an RP of the frame that is operated by the relay coordinator.

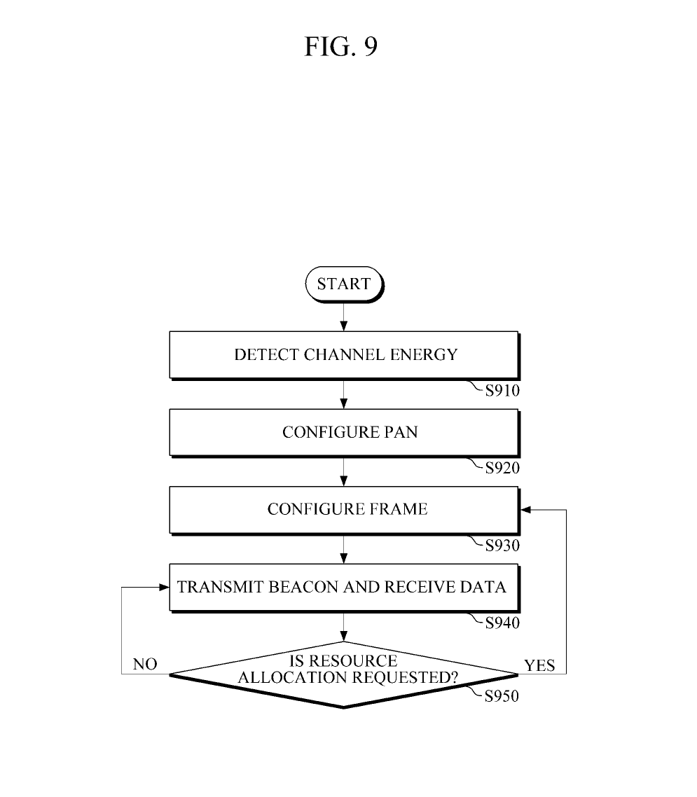

FIG. 9 is a diagram illustrating an example of a method for controlling radio resource allocation for a low power sensor communication service by a PAN coordinator.

Referring to FIG. 9, as power turns on, the PAN coordinator detects channel energy for channel selection in S910. Then, according to the channel selection, the PAN coordinator is configures a PAN in S920. That is, the PAN coordinator regularly transmits a beacon through the selected channel, and configures the PAN as devices within a coverage area detecting the beacon join in the PAN.

Then, the PAN coordinator sets a configuration of a frame that includes a CAP offset and a CFP offset for resource allocation of one or more lower hierarchical coordinators or sensor devices in S930. This operation is the same as the description referring to FIG. 5

The PAN coordinator generates a beacon frame that includes frame configuration information, transmits the beacon frame to each of the devices that form the PAN, and receives data from each device that transmits the data based on the beacon frame in S940.

Also, the PAN coordinator monitors whether the devices request resource allocation in S950.

After the operation S950, in a case where the devices request the resource allocation, the PAN coordinator executes an operation S930, where a CFP length is changed, and the like. Otherwise, the PAN coordinator executes an operation S940.

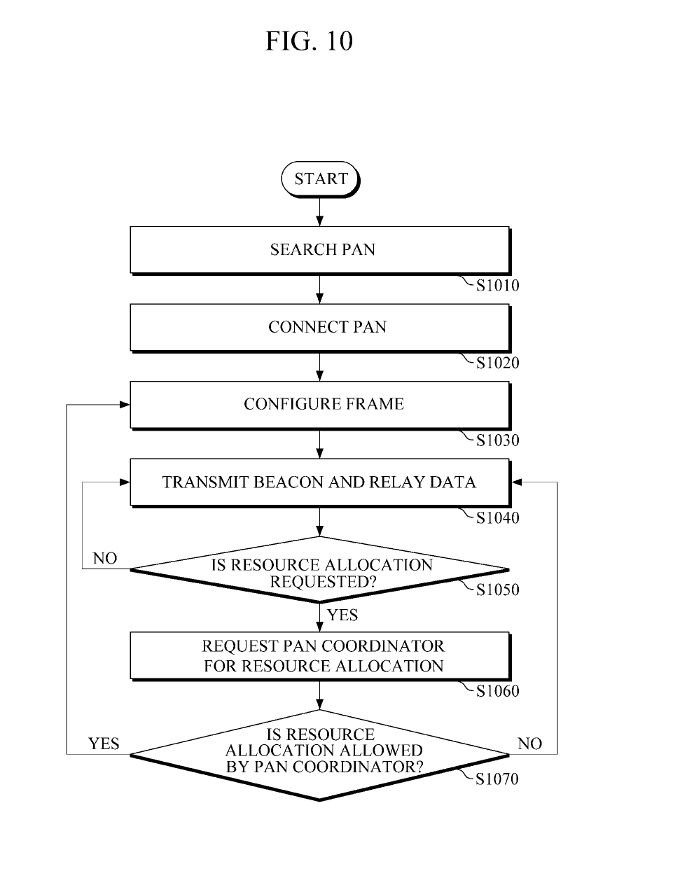

FIG. 10 is a flowchart illustrating an example of a method for controlling radio resource allocation for a low power sensor communication service by a relay coordinator.

Referring to FIG. 10, as power turns on, a relay coordinator searches a PAN in S1010, and connects the relay coordinator to the searched PAN in S1020.

Also, the relay coordinator sets a configuration of a frame that includes a CAP offset and a CFP offset for resource allocation of one or more lower hierarchical coordinators or sensor devices in S1030. This operation is the same as the description referring to FIGS. 6 and 7.

The relay coordinator generates a beacon frame that includes frame configuration information, transmits the beacon frame to each of the lower hierarchical coordinators or sensor devices, and executes data relaying between each device and the PAN coordinator which both transmit the data based on the beacon frame in S1040. This operation is the same as the description referring to FIGS. 7 and 8.

In addition, the relay coordinator monitors whether the devices request resource allocation in S1050.

After the operation S1050, in a case where the devices request the resource allocation, the relay coordinator requests the PAN coordinator for resource allocation. In other words, an active period of the frame operated by the relay coordinator is relevant to an inactive period of the frame operated by the PAN coordinator, so the operation requests expansion of the inactive period.

After the request, in a case where resource allocation is allowed by the PAN coordinator, namely, which information about the expansion of the inactive period is received, the relay coordinator executes the frame configuration again in S1030.

However, in a case where the resource allocation is not requested in S1050, or not allowed by the PAN coordinator in S1070, the relay coordinator executes the operation S1040.

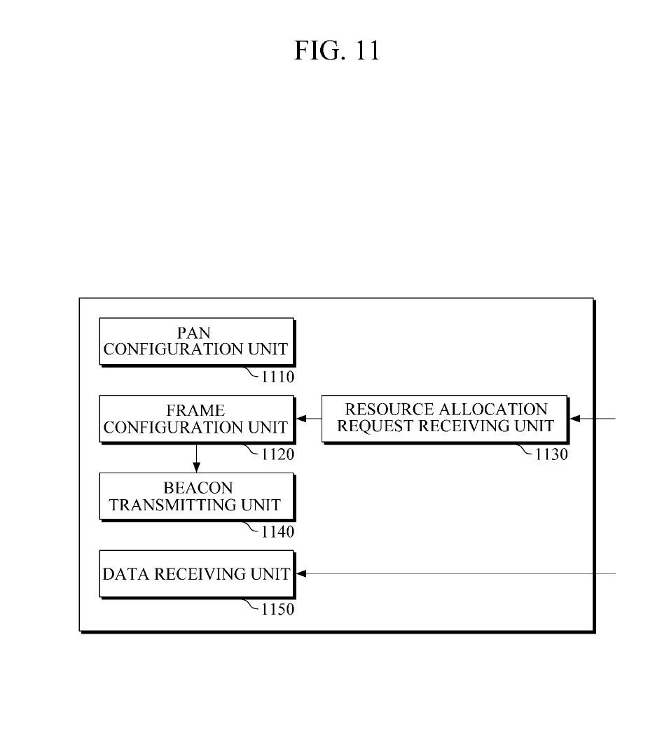

FIG. 11 is a diagram illustrating an example of a PAN coordinator allocating radio resources for a low power sensor communication service.

Referring to FIG. 11, a PAN coordinator includes PAN configuration unit 1110, a frame configuration unit 1120, a resource allocation request receiving unit 1130, a beacon transmitting unit 1140, and a data receiving unit 1150.

A PAN configuration unit 1110 detects energy from a plurality of channels, and selects one channel, regularly transmits a beacon through the channel, and configures the PAN as devices within a coverage area detecting the beacon join in the PAN.

A frame configuration unit 1120 configures a frame that includes a CAP offset and a CFP offset of variable sizes. This operation is the same as the description referring to FIG. 5.

A resource allocation request receiving unit 1130 is asked for resource allocation from one or more lower hierarchical coordinators or sensor devices, and outputs results. Then, the frame configuration unit 1120 changes the frame configuration that includes the CAP offset and the CFP offset of variable sizes, as the resource allocation is asked.

A beacon transmitting unit 1140 generates a beacon frame including information of the frame configuration, and transmits the beacon frame to the one or more lower hierarchical coordinators or sensor devices.

A data receiving unit 1150 receives data through the CFP allocated from the one or more lower hierarchical coordinators or sensor devices according to the information of the frame configuration.

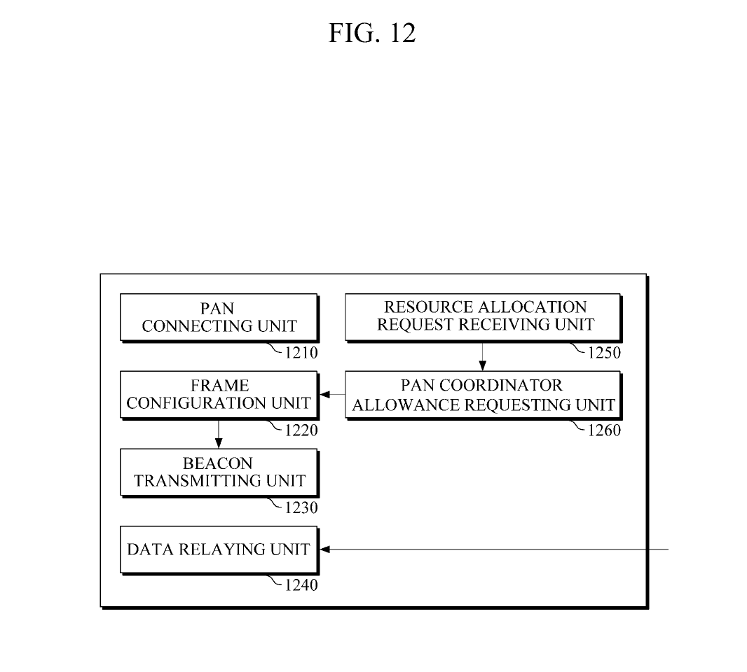

FIG. 12 is a diagram illustrating an example of a relay coordinator allocating radio resources for a low power sensor communication service.

Referring to FIG. 12, a relay coordinator includes a PAN connecting unit 1210, a frame configuration unit 1220, a beacon transmitting unit 1230, a data relaying unit 1240, a resource allocation request receiving unit 1250, and a PAN coordinator allowance requesting unit 1260.

A PAN connecting unit 1210 searches a PAN, and connects the relay coordinator to the searched PAN.

A frame configuration unit 1220 configures a frame that includes a CAP offset and a CFP offset of variable sizes, a PAN coordinator, and a relay period (RP) for relaying data of lower hierarchical devices. This operation is same as the description referring to FIGS. 6 and 7.

A beacon transmitting unit 1230 generates a beacon frame that includes information of is the frame configuration, and transmits the beacon frame to lower hierarchical devices.

A data relaying unit 1240 transmits data, which is received from the lower hierarchical devices through the CFP, to the PAN coordinator through the relay period (RP). Or the data relaying unit 1240 transmits data, received from the PAN coordinator through the RP, to lower hierarchical nodes. Those operations are the same as the description referring to FIGS. 7 and 8.

A resource allocation request receiving unit 1250 is asked for the resource allocation by the sensor devices connected to the lower hierarchical devices.

A PAN coordinator allowance requesting unit 1260 requests the PAN coordinator for the resource allocation as the resource allocation request receiving unit 1250 requests resource allocation, and receives allowance information. In other words, an active period of the frame operated by the relay coordinator is relevant to an inactive period of the frame operated by the PAN coordinator, so the operation requests expansion of the inactive period.

Then, as receiving information of the resource allocation from the PAN coordinator, the frame configuration unit 1220 changes the frame configuration including the CAP offset and the CFP offset of variable sizes.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions is include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for controlling radio resource allocation for a low power sensor communication service by a Personal Area Network (PAN) coordinator, comprising:
configuring a frame that includes a Competition Access Period (CAP) offset and a Competition Free Period (CFP) offset of variable sizes; and
generating a beacon frame that includes information of the frame configuration, and transmitting the beacon frame to one or more lower hierarchical coordinators or sensor devices.

2. The method of claim 1, wherein the configuring of the frame comprises setting the CAP offset as a basic slot unit from a beginning of a wireless frame, and setting the CFP offset as the basic slot unit from a point in time when the CAP offset ends.

3. The method of claim 1, wherein the CAP offset and the CFP offset are defined with a number of basic slots, a sum of which is within a range of a beacon interval.

4. The method of claim 1, further comprising:
being requested for resource allocation by the one or more lower hierarchical coordinators or sensor devices; and
changing the frame configuration.

5. A method for controlling radio resource allocation for a low power sensor communication service by a relay coordinator, comprising:
configuring a frame that includes a CAP offset and a CFP offset of variable sizes, and a relay period (RP) that relays data between the PAN coordinator and one or more lower hierarchical devices;
generating a beacon frame that includes information of the frame configuration, and transmitting the beacon frame to the one or more lower hierarchical devices; and
transmitting data, which is received from the one or more lower hierarchical devices through the CFP, to the PAN coordinator through the RP, or transmitting data, which is received from the PAN coordinator through the RP, to lower hierarchical nodes through the CFP.

6. The method of claim 5, wherein a sum of the CAP offset, the CFP offset, the RP offset, and a RP length is within a range of a beacon interval.

7. The method of claim 5, wherein a beacon interval transmitted from the relay coordinator has a same length as a beacon interval transmitted from the PAN coordinator.

8. The method of claim 5, wherein a starting point of a beacon transmitted from the relay coordinator exists after a starting point of an inactive period of the frame operated by the PAN coordinator.

9. The method of claim 5, wherein a sum of the beacon, the CAP, and the CFP, of the relay coordinator is less than an inactive period of the PAN coordinator.

10. The method of claim 5, wherein the CFP, which is allocated to the relay coordinator by the PAN coordinator, is identical to the RP of the relay coordinator.

11. The method of claim 5, further comprising:
being requested for resource allocation by lower hierarchical sensor devices;
in response to being requested for the resource allocation, requesting the PAN coordinator for the resource allocation; and
in response to receipt of information of the resource allocation from the PAN coordinator, changing configuration of the frame that includes the CAP offset and the CFP offset of variable sizes.

12. A PAN coordinator, comprising:
a frame configuration unit configured to configure a frame that includes a CAP offset and a CFP offset of variable sizes; and
a beacon transmitting unit configured to generate a beacon frame that includes information of frame configuration, and transmit the beacon frame to one or more lower is hierarchical coordinators or sensor devices.

13. The PAN coordinator of claim 12, further comprising:
a PAN configuration unit configured to configure a PAN, in response to energy of a plurality of channels being detected, one channel being selected, a beacon being periodically transmitted through the channel, and devices, within a coverage area detecting the beacon, being joined in the PAN.

14. The PAN coordinator of claim 12, further comprising:
a data receiving unit configured to, depending on the information of the frame configuration, receive data through the CFP allocated by the one or more lower hierarchical coordinators or sensor devices.

15. The PAN coordinator of claim 12, further comprising:
a resource allocation request receiving unit configured to receive a resource allocation request from the one or more lower hierarchical coordinators or sensor devices, and
wherein the frame configuration unit is configured to, in response to the resource allocation request, change the frame configuration.

16. A relay coordinator, comprising:
a frame configuration unit configured to configure a frame that includes a CAP offset and a CFP offset of variable sizes, and a RP that relays data between a PAN coordinator and one or more lower hierarchical devices;
is a beacon transmitting unit configured to generate a beacon frame that includes information of the frame configuration, and to transmit the beacon frame to the one or more lower hierarchical devices; and
a data relaying unit configured to transmit data, which is received from the one or more lower hierarchical devices through a CFP, to the PAN coordinator through the RP, or transmit data, which is received from the PAN coordinator through the RP, to the one or more lower hierarchical nodes through a CFP.

17. The relay coordinator of claim 16, further comprising:
a resource allocation request receiving unit configured to be requested for resource allocation by the one or more lower hierarchical devices; and
a PAN coordinator allowance requesting unit configured to, in response to the resource allocation being requested, request the PAN coordinator for the resource allocation, and
wherein the frame configuration unit configured to, in response to information of the resource allocation being received from the PAN coordinator, change the frame configuration.
